(19) United States
(12) Patent Application Publication
(10) Pub. No.: US 2025/0238983 A1
(43) Pub. Date: Jul. 24, 2025

(54) SYSTEMS AND TECHNIQUES FOR MODIFYING IMAGE DATA

(71) Applicant: QUALCOMM Incorporated, San Diego, CA (US)

(72) Inventors: Kuang-Jui HSU, Zhunan Township (TW); Michel Adib SARKIS, San Diego, CA (US)

(21) Appl. No.: 18/418,040

(22) Filed: Jan. 19, 2024

(51) Int. Cl. G06T 11/60; G06V 10/25; G06V 10/44; G06V 10/771

(52) U.S. Cl. CPC G06T 11/60; G06V 10/25; G06V 10/44; G06V 10/771

(57) ABSTRACT

Systems and techniques are described herein for modifying images. For instance, a method for modifying images is provided. The method may include generating first feature maps based on a first input image and a target scale ratio; refining the first feature maps to generate refined first feature maps; generating second feature maps based on the first input image and a second input image; and generating a modified image based on the refined first feature maps and the second feature maps.

### TECHNICAL FIELD

The present disclosure generally relates to modifying image data. For example, aspects of the present disclosure include systems and techniques for increasing the resolution (e.g., by applying a super-resolution technique) to image data (e.g., image frames of video data).

### BACKGROUND

Video super-resolution (VSR) is a process of generating high-resolution image frames based on low-resolution image frames. For example, a VSR technique may obtain video data including number of image frames. Each of the image frames may be made up of a first number of pixels. The VSR technique may modify each of the image frames to include a second number of pixels that is greater than the first number of pixels. Additionally or alternatively, a VSR technique may be applied to a region of interest (ROI) of image frames.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

Systems and techniques are described for modifying images. According to at least one example, a method is provided for modifying images. The method includes: generating first feature maps based on a first input image and a target scale ratio; refining the first feature maps to generate refined first feature maps; generating second feature maps based on the first input image and a second input image; and generating a modified image based on the refined first feature maps and the second feature maps.

In another example, an apparatus for modifying images is provided that includes at least one memory and at least one processor (e.g., configured in circuitry) coupled to the at least one memory. The at least one processor configured to: generate first feature maps based on a first input image and a target scale ratio; refine the first feature maps to generate refined first feature maps; generate second feature maps based on the first input image and a second input image; and generate a modified image based on the refined first feature maps and the second feature maps.

In another example, a non-transitory computer-readable medium is provided that has stored thereon instructions that, when executed by one or more processors, cause the one or more processors to: generate first feature maps based on a first input image and a target scale ratio; refine the first feature maps to generate refined first feature maps; generate second feature maps based on the first input image and a second input image; and generate a modified image based on the refined first feature maps and the second feature maps.

In another example, an apparatus for modifying images is provided. The apparatus includes: means for generating first feature maps based on a first input image and a target scale ratio; means for refining the first feature maps to generate refined first feature maps; means for generating second feature maps based on the first input image and a second input image; and means for generating a modified image based on the refined first feature maps and the second feature maps.

In some aspects, one or more of the apparatuses described herein is, can be part of, or can include an extended reality (XR) device (e.g., a virtual reality (VR) device, an augmented reality (AR) device, or a mixed reality (MR) device), a vehicle (or a computing device, system, or component of a vehicle), a mobile device (e.g., a mobile telephone or so-called “smart phone”, a tablet computer, or other type of mobile device), a smart or connected device (e.g., an Internet-of-Things (IoT) device), a wearable device, a personal computer, a laptop computer, a video server, a television (e.g., a network-connected television), a robotics device or system, or other device. In some aspects, each apparatus can include an image sensor (e.g., a camera) or multiple image sensors (e.g., multiple cameras) for capturing one or more images. In some aspects, each apparatus can include one or more displays for displaying one or more images, notifications, and/or other displayable data. In some aspects, each apparatus can include one or more speakers, one or more light-emitting devices, and/or one or more microphones. In some aspects, each apparatus can include one or more sensors. In some cases, the one or more sensors can be used for determining a location of the apparatuses, a state of the apparatuses (e.g., a tracking state, an operating state, a temperature, a humidity level, and/or other state), and/or for other purposes.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative examples of the present application are described in detail below with reference to the following figures:

FIG. 1 is a representation of an example system for modifying image data, according to various aspects of the present disclosure;

FIG. 2 is a block diagram illustrating an example system for modifying images, according to various aspects of the present disclosure;

FIG. 3 is a block diagram of an example backbone network for generating image features, according to various aspects of the present disclosure;

FIG. 4 is a block diagram illustrating an example up-sampling network for generating predicted results and an example post-processor for generating SR image frames, according to various aspects of the present disclosure;

FIG. 5 is a flow diagram illustrating a process for modifying image data, in accordance with aspects of the present disclosure;

FIG. 6 is a block diagram illustrating an example of a deep learning neural network that can be used to perform various tasks, according to some aspects of the disclosed technology;

FIG. 7 is a block diagram illustrating an example of a convolutional neural network (CNN), according to various aspects of the present disclosure; and

FIG. 8 is a block diagram illustrating an example computing-device architecture of an example computing device which can implement the various techniques described herein.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the exemplary aspects will provide those skilled in the art with an enabling description for implementing an exemplary aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage, or mode of operation.

As mentioned above, video super-resolution (VSR) techniques may be used to increase resolution of image frames. For example, VSR techniques may be used to increase the number of pixels of image frames of video data or increase the number of pixels used to represent regions of interest (ROIs) in image frames of the video data. In the present disclosure, the term “resolution” may be used as a relative term to describe a number of pixels used to represent all, or a portion of, a field of view represented by an image. For example, a first image may represent a field of view of a camera (or an ROI within the field of view) with 1920*1080 pixels. 1920*1080 may describe the resolution of the first image. A second image may represent the same field of view (or the same ROI within the field of view) with 3840*2160 pixels. 3840*2160 may describe the resolution of the second image. The resolution of the second image may be described as quadruple the resolution of the first image because the second image represents the same field of view with four times as many pixels as the first image.

Machine learning models (e.g., neural networks, such as convolutional neural networks (CNNs)) can be used to perform VSR techniques to generate high-quality video data by increasing the resolution of image frames of input video data. Because machine-learning-based solutions (e.g., CNNs) can move complex optimization to an offline training stage (where a machine-learning model can be trained), an online inference stage for the machine-learning model can be fast and can, in some cases, achieve real-time performance. Such machine-learning-based solutions may be suitable to consumer-level devices, such as mobile devices, extended reality (XR) devices, vehicle systems, etc.

However, such machine-learning-based solutions may be able to increase the resolution by only a set ratio based on the training of the machine-learning models. For example, a machine-learning model may be trained to double a resolution of image data. The machine-learning model may be capable of doubling the resolution of any image data. However the machine-learning model may not be capable of tripling or quadrupling the resolution of image data because the machine-learning model was not trained to triple or quadruple the resolution of image data.

Systems, apparatuses, methods (also referred to as processes), and computer-readable media (collectively referred to herein as “systems and techniques”) are described herein for modifying image data. For example, the systems and techniques described herein may increase a resolution of image frames of video data by an arbitrary up-sampling ratio. For example, the systems and techniques may be provided with video data and a target scale ratio. The target scale ratio may be any positive real number. In some cases, the target scale ratio may be an integer. The systems and techniques may increase the resolution of the video data based on the target scale ratio. In one illustrative example, the systems and techniques may obtain video data with a resolution of 1920*1080 and a target scale ratio of 2.5. The systems and techniques may modify the video data to have a resolution of 3036*1708 (e.g., 2.5 times the resolution of the input video data). In the present disclosure, the terms “up-scale” and “increase the resolution of,” with reference to video data, may refer to the process of changing a resolution (or number of pixels) of all or a portion of image frames of the video data.

For example, a user may be viewing video data at a resolution of 1920*1080 (e.g., each image frame of the video data may be 1920*1080 pixels in size). The user may select an ROI within the video data as the video data is being displayed. The ROI may be a 500*500 pixel portion of each image frame of the video data. The systems and techniques may increase the resolution of the ROI (e.g., of the ROI within each image frame of the video data, for example, to 1080*1080) and display the ROI with the increased resolution (e.g., instead of the original video data).

To increase the resolution of the video data, the systems and techniques may generate respective scale-aware feature maps based on each image frame of the video data and the target scale ratio. The systems and techniques may refine the scale-aware feature maps to generate refined scale-aware feature maps. Further, the systems and techniques may generate backbone feature maps based on multiple image frames of the video data. The systems and techniques may generate modified image frames of modified video data based on the refined scale-aware feature maps and the backbone feature maps.

The systems and techniques may be used in a number of tasks, such as image segmentation, video segmentation, video face tracking, and/or facial-avatar generation. Implementing the systems and techniques in such tasks, instead of other VSR techniques, may reduce the latency of the tasks. Additionally or alternatively, the systems and techniques may be used for any system requiring real-time video processing such as animation or extended reality (XR) because using input videos with the small resolutions could reduce the running time, and the systems and techniques may enhance the quality of the HR results. As an example, many mobile applications, such as face beautification, require video inputs. Directly using face beautification on a high-resolution video may require a large amount of memory, processing time, and/or power. Accordingly, performing face beautification on high-resolution video may not be suitable for the mobile devices. However, the input videos could be first down-sampled, and then the face-beautification method could be applied on the down-sampled video. Finally, the beautification results could be up-scaled by the systems and techniques. By down-sampling, performing a task, then up-scaling, the systems and techniques may conserve computational resources which may cause face beautification or other applications to be more suitable for running on mobile devices.

The systems and techniques may be up-scale input images by an arbitrary scale ratio. As mentioned above other VSR techniques may be limited to scaling based on a fixed scale ratio based on the training of machine-learning models of the other VSR techniques. In contrast, the systems and techniques may up-scale input images (e.g., image frames of video data) by any scale ratio, for example, by any positive real number, which may or may not be an integer. Additionally or alternatively, the systems and techniques may use less memory than other VSR techniques and/or run more quickly than other VSR techniques because the systems and techniques may include different machine-learning models than the other VSR techniques.

Various aspects of the application will be described with respect to the figures below.

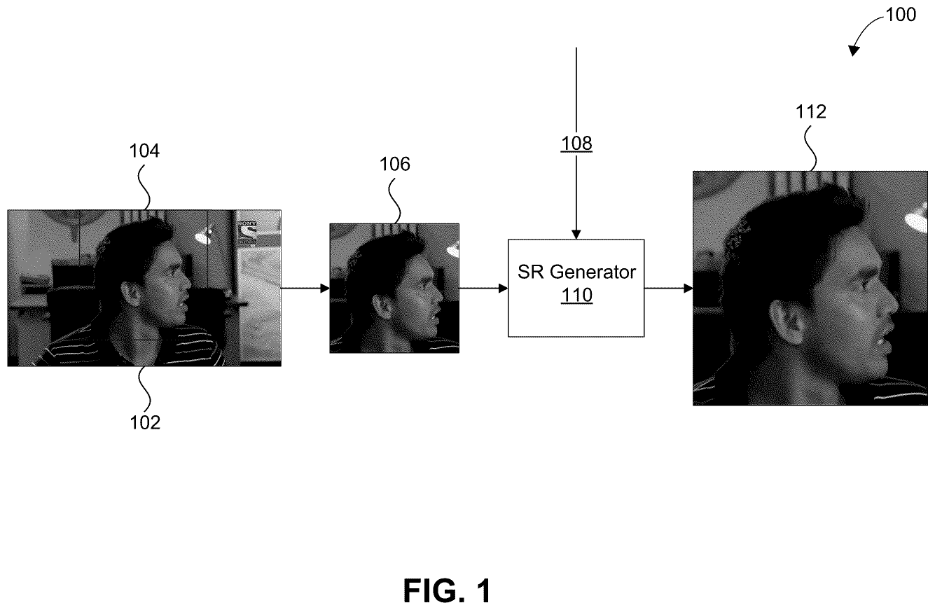

FIG. 1 is a representation of an example system 100 for modifying image data, according to various aspects of the present disclosure. In general, system 100 includes an SR generator 110 that may obtain image data (e.g., cropped video 106) and a scale ratio 108 and up-scale the image data (e.g., cropped video 106) based on scale ratio 108 to generate up-scaled video data (e.g., super-resolution (SR) video 112).

Input video 102 may be an example image data that may be modified, according to various aspects of the present disclosure. Input video 102 may be made up of a number of image frames, one of which is illustrated in FIG. 1.

Region of interest (ROI) 104 is a representation of a portion of input video 102. ROI 104 may be determined based on an input of a user. For example, a user may select ROI 104. The user may indicate ROI 104 with a touch or a gaze. For instance a gaze-detection system may determine ROI 104 based on a gaze of the user. ROI 104 may be persistent throughout image frames of input video 102. For example, ROI 104 may indicate pixels in the same location within a respective image frame of each image frame of input video 102. Cropped video 106 is a representation of the pixels of input video 102 within ROI 104 at the resolution of the pixels of ROI 104 within input video 102.

In some aspects, system 100 may crop cropped video 106 from input video 102 and provide cropped video 106 to SR generator 110. For example, in some aspects, system 100 may generate data representative of cropped video 106 based on input video 102. In other aspects, system 100 may provide input video 102 as a whole and ROI 104 to SR generator 110.

Scale ratio 108 may be an arbitrary scale ratio. Scale ratio 108 may be any positive real number. Scale ratio 108 may, or may not, be an integer. Scale ratio 108 may be based on a size of ROI 104 and/or a size (or resolution) of a display. For example, in some aspects, scale ratio 108 may be defined based on a size of ROI 104 and a size and/or resolution of a display at which SR video 112 is to be displayed (e.g., such that SR video 112 fills the display at the full resolution of the display). In other aspects, scale ratio 108 may be determined based on some other criteria or provided (e.g., by a user).

SR generator 110 may be, or may include, one or more machine-learning models trained to modify image data to generate up-scaled image data. SR generator 110 may generate SR video 112 based on cropped video 106 (or input video 102 and ROI 104) and scale ratio 108. SR video 112 may represent ROI 104 of input video 102 with more pixels than are included in ROI 104. For example, based on scale ratio 108 being 4, SR video 112 may include 4 times as many pixels as ROI 104.

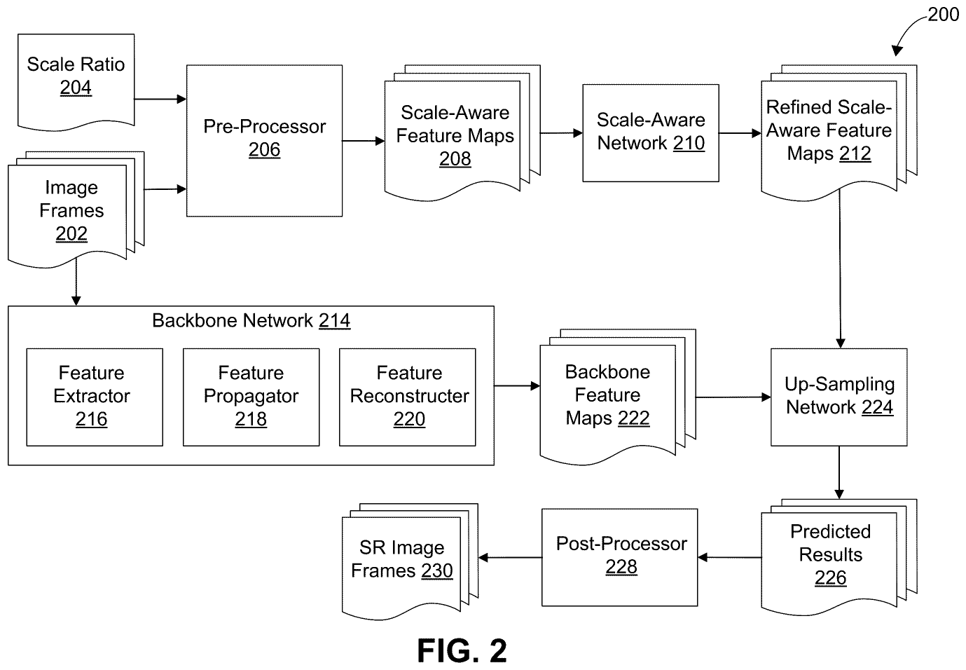

FIG. 2 is a block diagram illustrating an example system 200 for modifying images, according to various aspects of the present disclosure. System 200 may be an example of super resolution (SR) generator 110 of FIG. 1. For example, system 200 may obtain image frames 202 (which may be an example of image frames of input video 102 of FIG. 1) and scale ratio 204 (which may be an example of scale ratio 108 of FIG. 1). System 200 may generate SR image frames 230 (which may be an example image frame of SR video 112 of FIG. 1) based on image frames 202 and scale ratio 204.

Image frames 202 may be, or may include, two or more image frames (e.g., of video data). Image frames 202 may include successive image frames. Successive image frames may be similar because the successive image frames may represent the same scene as captured at a frame capture rate (e.g., 30, 60, 90, or 120 frames per second (fps)). The scene may not change much between the times when successive image frames are captured.

Scale ratio 204 may be an arbitrary scale ratio. Scale ratio 204 may be any positive real number. Scale ratio 204 may, or may not, be an integer. Scale ratio 204 may be based on a size of an ROI and/or a size (or resolution) of a display. For example, in some aspects, scale ratio 204 may be defined based on a size of ROI and a size and/or resolution of a display at which SR image frames 230 is to be displayed (e.g., such that SR image frames 230 fills the display at the full resolution of the display). In other aspects, scale ratio 204 may be determined based on some other criteria or provided (e.g., by a user).

Pre-processor 206 may generate scale-aware feature maps 208 based on scale ratio 204 and image frames 202. Pre-processor 206 may be, or may include, one or more machine-learning models trained to generate scale-aware feature maps based on image frames and scale ratio. Pre-processor 206 may generate a set of scale-aware feature maps 208 based on each of image frames 202. System 200 may use the relationship between the coordinates of the low-resolution images and the high-resolution images. For example, pre-processor 206 may generate scale-aware feature maps 208 by calculating coordinates and relative distances based on one of image frames 202 and scale ratio 204 as scale-aware feature maps 208. For example, in system 200, the geometric relationship between each pixel locations in image frames 202 and predicted results 226 are captured in pre-processor 206. The geometric relationship is encoded in scale-aware feature maps 208, and it is useful to identify and recover the details in predicted results 226 with the scale ratio 204.

Scale-aware network 210 may refine scale-aware feature maps 208 to generate refined scale-aware feature maps 212. Scale-aware network 210 may be, or may include, one or more machine-learning models, trained to generate refined scale-aware feature maps based on scale-aware feature maps. For example, refined scale-aware feature maps 212 may use a simple residual net as scale-aware net to refine the scale-aware feature maps. For example, scale-aware network 210 may use a scale-aware machine-learning model to generate refined scale-aware feature maps 212 based on scale-aware feature maps 208. For example, directly using scale-aware feature maps 208 may not be good enough to represent the geometric relationship, so scale-aware feature maps 208 may be refined by scale-aware network 210 to generate refined scale-aware feature maps 212. Scale-aware network 210 may be, or may include, a residual net because a residual net could capture and refine the geometric relationship with the residual connection. Also, residual nets are fast but powerful, so a residual net would fit well with system 200.

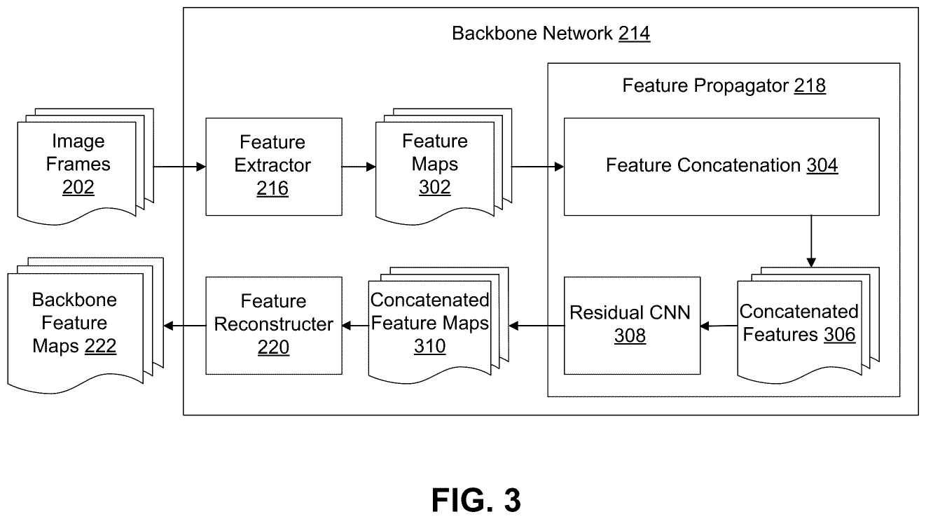

Backbone network 214 may generate backbone feature maps 222 based on image frames 202. Backbone network 214 may be, or may include, one or more machine-learning models trained to generate backbone feature maps based on image frames. Backbone network 214 may generate a set of backbone feature maps 222 based on pairs of image frames 202 for example, backbone network 214 may generate a set of backbone feature maps 222 based on each pair of successive image frames 202 of image frames 202. Backbone network 214 may use the concatenation layers between features from adjacent frames to capture the temporal consistency between adjacent frames. Additional detail regarding backbone network 214 is provided with regard to FIG. 3.

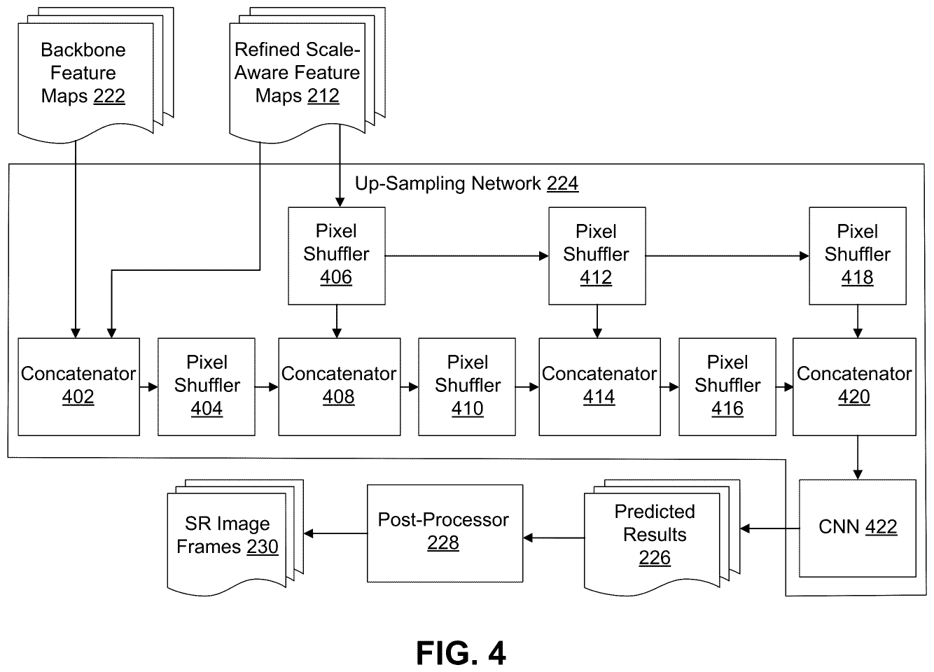

Up-sampling network 224 may generate predicted results 226 based on refined scale-aware feature maps 212 and backbone feature maps 222. Up-sampling network 224 may be, or may include, one or more machine-learning models trained to generate predicted results based on two separate sets of feature maps. Additional detail regarding up-sampling network 224 is provided with regard to FIG. 4.

Post-processor 228 may generate SR image frames 230 based on predicted results 226. Post-processor 228 may be, or may include, one more machine-learning models trained to generate SR images based on predicted results. Additional detail regarding post-processor 228 is provided with regard to FIG. 4.

System 200 may be trained in an end-to-end backpropagation training process. For example, all of the machine-learning models of system 200 may be trained together. For example, a corpus of training data may be obtained. The corpus of training data my include a number of training image frames and a corresponding number of ground-truth image frames. The training image frames may have a variety of scale ratios to the corresponding ground-truth image frames. For example, a first ground-truth image may be 5.6 times larger than a corresponding training image frame. Further, a second ground-truth image may be 3.5 times larger than corresponding training image frame.

The training process may involve providing the training images to system 200 along with the scale ratio between the training image and the corresponding ground-truth image. System 200 may generate a SR image frame. The generated SR image frame may be compared with the corresponding ground-truth image frame. A loss may be calculated based on differences between the generated SR image frame and the corresponding ground-truth image frame. Parameters (e.g., weights) of machine-learning models of system 200 may be adjusted based on the loss. The adjustment may be to decrease the loss in future iterations of the training process (e.g., according to a gradient descent technique). After adjusting the parameters, system 200 may be provided with another image and scale ratio and the process may be repeated.

Additionally or alternatively, one or more machine-learning models of system 200 may be trained independently. For example, in some aspects, scale-aware network 210 may be trained independently, and/or backbone network 214 may be trained independently.

In some aspects, one of the losses that may be a Charbonnier Loss. For example, the loss may be

$$Charbonnier Loss : {ℓ}_{c} = {\sum }_{t} \sqrt{{( {\hat{y}}_{t} - {y}_{t} )}^{2} + {ε}^{2}}$$

where ŷₜ represents the predicted HR result of the t frame;
where yₜ represents the ground-truth HR result of the t frame; and
where ε represents the small number.

Additionally, because temporal consistency may be important to VSR, temporal-consistency regularization may be used in the training of system 200. Temporal-consistency regularization may be considered during the training process. However, temporal-consistency regularization may not be used in the inference stage, so the complexity of system 200 may not be increased by temporal-consistency regularization.

The warping error between the adjacent frames is minimized in the temporal consistency regularization, and its formulation is in the following:

$$temporal consistency regularization : {ℓ}_{t} = {\sum }_{t} {M}_{t ⇒ t - 1} {\vert {\hat{y}}_{t} - {\hat{O}}_{t - 1} \vert}_{1}$$

where M_{t⇒t-1}: the visibility mask calculated from the warping error between t frame and warped t−1 frame; and
where Ôₜ₋₁: the frame ŷₜ₋₁ warped by the optical flow F_{t⇒t-1}.
   Temporal consistency regularization may be used as a loss function in training system 200 or in training backbone network 214.

To reduce the size, computational cost, and/or memory usage of system 200 compared with other VSR systems, backbone network 214 may be a lightweight real-time network. A lightweight real-time network may have low complexity and may not well fit the complex task of VSR with the arbitrary scale if the lightweight real-time is directly trained according to various aspects of the present disclosure.

In training system 200, backbone network 214 may be trained according to a knowledge-distillation process to improve the performance of the lightweight real-time network implementing backbone network 214. Knowledge distillation is the process of transferring knowledge from a one machine-learning model (which may be described as a teacher) to another machine-learning model (which may be described as a student). The student may be trained to mimic a teacher's behavior. Knowledge distillation usually involves using a pre-trained, large model as the teacher and a lightweight model as the student. For example, first, a large model (e.g., a complex VSR network) may be trained with as a teacher. Then, a student (e.g., a lightweight real-time network implementing backbone network 214) may be trained with the same solution, but with the two additional losses including the feature alignment loss and the output loss:

$$feature alignment loss = \{ \begin{matrix}{\sum }_{l} {\sum }_{i} {\vert {f}_{l , i}^{s} - {f}_{l , i}^{t} \vert}^{2} , & if {f}_{l , i}^{t} > 0 \\ {\sum }_{l} {\sum }_{i} {\vert {f}_{l , i}^{s} - 0 \vert}^{2} , & if {f}_{l , i}^{t} \leq 0 and {f}_{l , i}^{s} > 0\end{matrix}$$

where l and i are the indexes of the network and the feature map, respectively; and
where fₗ^{s} and fₗ^{s} are the l layer feature maps of the student and teacher, respectively.

$$output loss = {\sum }_{i} \vert {o}_{i}^{s} - {o}_{i}^{t} \vert$$

where i is the index of the network output; and
where o^{s} and o^{t} are the outputs of the teacher and student, respectively.

The teacher could contain the any complex modules for the temporal, and the student could not. Therefore, the feature alignment loss could also let student learn the temporal consistency from the teacher.

Although not illustrated in FIG. 2, each convolutional layer in system 200 may include a parametric rectified linear unit (PReLU). For example, in some aspects, one or more activation layers may be replaced with PReLUs to improve the performance of machine-learning models of system 200. For PReLU, the coefficient of the negative part is not constant and is adaptively learned, so PReLU makes the student well model the complex VSR. However, there are some learnable parameters in PReLU, but the total number of parameters is still less.

FIG. 3 is a block diagram of an example backbone network 214 for generating image features, according to various aspects of the present disclosure. FIG. 3 provides additional detail regarding backbone network 214 of FIG. 2. Backbone network 214 may use the concatenation layers between features from adjacent frames to capture the temporal consistency between adjacent frames.

Backbone network 214 may be similar to other machine-learning models trained to generate features based on images. Further, backbone network 214 may be similar to other machine-learning models trained to perform video super-resolution (VSR). However, unlike other techniques for implementing VSR, backbone network 214 may exclude some modules that use a relatively large amounts of memory and/or consume relatively large amounts of time when performing their respective tasks. For example, backbone network 214 may omit modules related to flow warp, deformable convolution, recurrent neural networks (RNNs), long short-term memory (LSTM).

Feature extractor 216 may be, or may include, a machine-learning model (e.g., a neural network) trained to extract features of image frames 202. Feature extractor 216 may be, or may include, a feature-extraction residual block and/or a powerful convolutional neural network (CNN) block or module. Feature extractor 216 may generate feature maps 302 based on image frames 202. Feature maps 302 may include a set of feature maps 302 for each image frame of image frames 202. For example, in some aspects, feature maps 302 may include 16 feature maps 302 for each image frame of image frames 202.

Feature concatenation 304 of feature propagator 218 may concatenate features from adjacent frames (e.g., from a first image frame and an immediately following frame) to generate concatenated features 306. Feature concatenation 304 may be, or may include, a cheap residual block (e.g., in terms of computational expenses including memory usage, power consumption, and/or processing time). Feature concatenation 304 may maintain the temporal consistency between frames. Feature concatenation 304 may allow backbone network 214 to omit other, more costly modules (e.g., in terms of computational expenses). Feature concatenation 304 may concatenate sets of feature maps 302 across the feature-map dimension. For example, for a given input image of image frames 202, feature maps 302 may include feature maps 302 having dimensions 16*W*H (where W is width, where H is height, and the height and width relate to the dimensions of the input image of image frames 202). Feature concatenation 304 may concatenate feature maps 302 from two input images of image frames 202 such that concatenated features 306 has dimensions of 32*W*H.

Residual CNN 308 may generate concatenated feature maps 310 based on concatenated features 306. Residual CNN 308 may be, or may include, one or more residual blocks and/or CNN layers trained to generate feature maps based on features. For example, directly using concatenation in feature concatenation 304 may not be powerful enough to capture the complex relationship and temporal consistency between adjacent frames, so a simple but powerful machine-learning model may be used to refine feature concatenation 304. Residual CNN 308 is used because it could well capture and present the complex temporal consistency with the residual connection. Residual CNN 308 is fast but powerful, so it is suitable for use in feature propagator 218.

Feature reconstructor 220 may generate backbone feature maps 222 based on concatenated feature maps 310. Feature reconstructor 220 may be, or may include, one or more residual blocks trained to generate feature maps based on other feature maps. For example, in feature reconstructor 220, two kinds of domains (i.e., the spatial information generated from feature extractor 216 and the temporal information generated from feature propagator 218) are both considered. Considering these two kinds of complementary information at the same time is a difficult job, so feature reconstructor 220 may be, or may include, a residual CNN with several residual blocks. Residual connections in the residual CNNs are powerful and could well fuse these two kinds of the information. Thus feature reconstructor 220 may be, or may include, a residual CNN. Additionally, residual CNNs may be simply modified, and thus a residual CNN could be designed to fit a mobile device and may be able to quickly perform operations related to feature reconstructor 220.

FIG. 4 is a block diagram illustrating an example up-sampling network 224 for generating predicted results 226 and an example post-processor 228 for generating SR image frames 230, according to various aspects of the present disclosure. FIG. 4 provides additional detail with regard to up-sampling network 224 of FIG. 2 and post-processor 228 of FIG. 2. In general up-sampling network 224 may use several pixel shuffle blocks to up-scale features and use concatenation layers to connect up-scaled features.

For example, concatenator 402 may concatenate backbone feature maps 222 and refined scale-aware feature maps 212. Backbone feature maps 222, which may be based on two images, may have dimensions of 16*W*H (where W is width, where H is height, and where the height and width relate to the dimensions of the two images). Refined scale-aware feature maps 212, which may be based on an image (e.g., one of the two images on which backbone feature maps 222 is based), may have dimensions of 16*W*H. Concatenator 402 may concatenate backbone feature maps 222 and refined scale-aware feature maps 212 such that the result has dimensions of 32*W*H.

Pixel shufflers of up-sampling network 224 (e.g., pixel shuffler 404, pixel shuffler 406, pixel shuffler 410, pixel shuffler 412, pixel shuffler 416, and pixel shuffler 418) may include at least one convolution layer and at least one pixel shuffle layer. The channel size of the output for each of the pixel shufflers is 4. In each of the pixel shufflers, the convolution layer is used first and followed by the pixel shuffle layer. First, the convolutional layer may reduce the channel size of the output of the pixel shuffle layer to reduce memory usage and/or running time of up-sampling network 224. For example, pixel shuffler 404 may rearrange elements of the output of concatenator 402. The input of the convolution layer of pixel shuffler 404, (e.g., the output of concatenator 402) has dimensions of 32*W*H. The convolution layer of pixel shuffler 404 reduces the channel size such that the output of convolution layer of pixel shuffler 404 has dimensions of 16*W*H. Secondly, the pixel shuffle layer of pixel shuffler 404 reorders the output of the convolution layer from 16*W*H to 4*2 W*2H.

Pixel shuffler 406 may rearrange elements of refined scale-aware feature maps 212. For example, pixel shuffler 406 may reorder elements of refined scale-aware feature maps 212 (which may have dimensions of 16*W*H) such that the output of pixel shuffler 406 has dimensions of 4*2 W*2H. In the convolution layer of pixel shuffler 406, the size of the output of refined scale-aware feature maps 212 remains 16*W*H. Next the pixel shuffle layer of pixel shuffler 406 reorders the output of the convolution layer from 16*W*H to 4*2 W*2H.

Concatenator 408 may concatenate the output of pixel shuffler 404 (which may have dimensions of 4*2 W*2H) with the output of pixel shuffler 406 (which may have dimensions of 4*2 W*2H). The output of concatenator 408 may have dimensions of 8*2 W*2H.

Pixel shuffler 404, pixel shuffler 406, and concatenator 408 may have effectively doubled the W and H dimensions of refined scale-aware feature maps 212 and backbone feature maps 222. If the output of concatenator 408 were decoded (from features to images) the results may be an image that has been doubled in size. Pixel shuffler 410, pixel shuffler 412, and concatenator 414 may operate in a similar fashion to effectively double the size of the output of concatenator 408.

Pixel shuffler 410 may rearrange elements of the output of concatenator 408. For example, pixel shuffler 410 may rearrange elements of the output of concatenator 408 (which may have dimensions of 16*2 W*2H) such that the output of pixel shuffler 410 has dimensions of 4*4 W*4H. In the convolution layer of pixel shuffler 410, the size of the output of concatenator 408 is changed from 8*2 W*2H to 16*2 W*2H. Next, the pixel shuffle layer of pixel shuffler 410 could reorder the output of the above convolution layer from 16*2 W*2H to 4*4 W*4H.

Pixel shuffler 412 may rearrange elements of the output of pixel shuffler 406. For example, pixel shuffler 412 may rearrange elements of the output of pixel shuffler 406 (which may have dimensions of 8*2 W*2H) such that the output of pixel shuffler 412 has dimensions of 2*4 W*4H. In the convolution layer of pixel shuffler 412, the size of the output of pixel shuffler 406 is changed from 4*2 W*2H to 16*2 W*2H. Next, the pixel shuffle layer of pixel shuffler 412 reorders the output of the convolution layer from 16*2 W*2H to 4*4 W*4H.

Concatenator 414 may concatenate the output of pixel shuffler 410 (which may have dimensions of 4*4 W*4H) with the output of pixel shuffler 412 (which may have dimensions of 4*4 W*4H). The output of concatenator 414 may have dimensions of 8*4 W*4H.

Pixel shuffler 410, pixel shuffler 412, and concatenator 414 may have effectively doubled the W and H dimensions of the output of concatenator 408. If the output of concatenator 414 were decoded (from features to images) the results may be an image that has been doubled in size compared to the output of concatenator 408 and quadrupled in size compared to refined scale-aware feature maps 212 or backbone feature maps 222. Pixel shuffler 416, pixel shuffler 418, and concatenator 420 may operate in a similar fashion to effectively double the size of the output of concatenator 414.

Up-sampling network 224 may include any number of pixel shufflers and concatenators to effectively increase the W and H dimensions of refined scale-aware feature maps 212 and backbone feature maps 222. Up-sampling network 224 may determine to include or use a number of pixel shufflers and concatenators based on a target scale ratio. For example, up-sampling network 224 may determine to use a number of pixel shufflers and concatenators to increase the W and H dimensions of the feature maps to exceed the target scale ratio. For example, if the target scale ratio is 5, up-sampling network 224 may use three sets of pixel shufflers and concatenators (e.g., as illustrated in FIG. 4) to increase W and H dimensions of the feature maps by 8 times.

Up-sampling network 224 may include CNN 422 that may generates predicted results 226 based on the output of concatenator 420. Predicted results 226 may be in the image domain. For example, CNN 422 may decode a feature map based on refined scale-aware feature maps 212 and backbone feature maps 222 and scaled by up-sampling network 224 to generate predicted results 226. CNN 422 may include one or more machine-learning models (e.g., a CNN) trained to generate results (e.g., images) based on feature maps.

Post-processor 228 may process predicted results 226 to generate SR image frames 230. Post-processor 228 may downscale predicted results 226 to generate SR image frames 230 based on the target scale ratio. For example, up-sampling network 224 may up-scale refined scale-aware feature maps 212 and backbone feature maps 222 beyond the original scale of the input images (e.g., to exceed the target scale ratio). Post-processor 228 may down-sample predicted results 226 such that SR image frames 230 is larger than the input images by the target scale ratio. For example, the target scale ratio may be 5. In such a case, up-sampling network 224 may up-scale the features by a factor of 8 such that predicted results 226 is 8 times larger than the input images. Predicted results 226 may down-sample predicted results 226 by a factor of ⅜ such that SR image frames 230 is 5 times larger than the input images. Post-processor 228 adjust predicted results 226 based on a dynamic float-point scale ratio. To downscale predicted results 226, post-processor 228 may use bilinear interpolation.

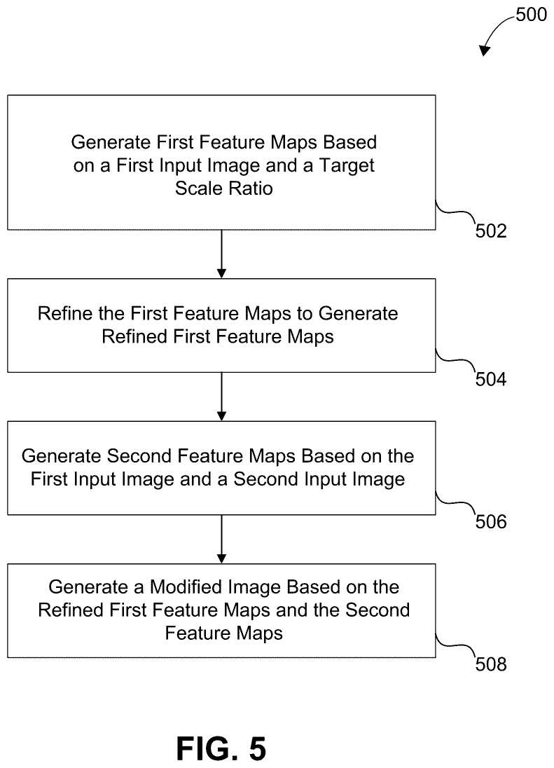

FIG. 5 is a flow diagram illustrating a process 500 for modifying image data, in accordance with aspects of the present disclosure. One or more operations of process 500 may be performed by a computing device (or apparatus) or a component (e.g., a chipset, codec, etc.) of the computing device. The computing device may be a mobile device (e.g., a mobile phone), a network-connected wearable such as a watch, an extended reality (XR) device such as a virtual reality (VR) device or augmented reality (AR) device, a vehicle or component or system of a vehicle, a desktop computing device, a tablet computing device, a server computer, a robotic device, and/or any other computing device with the resource capabilities to perform the process 500. The one or more operations of process 500 may be implemented as software components that are executed and run on one or more processors.

At block 502, a computing device (or one or more components thereof) may generate first feature maps based on a first input image and a target scale ratio. For example, pre-processor 206 of FIG. 2 may generate scale-aware feature maps 208 of FIG. 2 based on image frames 202 of FIG. 2 and scale ratio 204 of FIG. 2.

In some aspects, to generate the first feature maps, the computing device (or one or more components thereof) may calculate coordinates and relative distances based on the first input image and the target scale ratio. For example, pre-processor 206 may calculate coordinates (e.g., pixel coordinates) and relative distances (e.g., distances between pixel coordinates) of ROI 104 of FIG. 1 relative to SR video 112 of FIG. 1.

In some aspects, to generate the first feature maps, the computing device (or one or more components thereof) may project, based on the target scale ratio and a size of the first input image, pixel coordinates of a high-resolution image space to a low-resolution image space to determine pixel coordinates of the low-resolution image space. For example, pre-processor 206 may project pixels coordinates of a high-resolution image space (e.g., the image space of SR video 112 of FIG. 1, which may be based on scale ratio 108 of FIG. 1) to a low-resolution image space (e.g., the image space of ROI 104 of FIG. 1) to determine pixel coordinates of the low-resolution images space.

In some aspects, the computing device (or one or more components thereof) may determine relative distances between the pixel coordinates of a high-resolution image space and the pixels coordinates of the low-resolution image space. For example, pre-processor 206 may determine relative distances between pixels coordinates of the high-resolution image space (e.g., the image space of SR video 112 of FIG. 1, which may be based on scale ratio 108 of FIG. 1) and the low-resolution image space (e.g., the image space of ROI 104 of FIG. 1).

At block 504, the computing device (or one or more components thereof) may refine the first feature maps to generate refined first feature maps. For example, scale-aware network 210 of FIG. 2 may refine scale-aware feature maps 208 to generate refined scale-aware feature maps 212 of FIG. 2.

In some aspects, to refine the first feature maps, the computing device (or one or more components thereof) may use a scale-aware machine-learning model to generate the refined first feature maps based on the first feature maps. For example, system 200 of FIG. 2 may use scale-aware network 210 to refine scale-aware feature maps 208 to generate refined scale-aware feature maps 212.

At block 506, the computing device (or one or more components thereof) may generate second feature maps based on the first input image and a second input image. For example, backbone network 214 of FIG. 2 may generate backbone feature maps 222 of FIG. 2 based on image frames 202.

In some aspects, to generate the second feature maps, the computing device (or one or more components thereof) may: extract first features from the first input image; extract second features from the second input image; concatenate the first features with the second features to generate concatenated features; generate, using a residual block, concatenated feature maps based on the concatenated features; and reconstruct the concatenated feature maps to generate the second feature maps. For example, system 200 may use backbone network 214 of FIG. 2 and FIG. 3 to generate backbone feature maps 222 based on image frames 202. For example, at feature extractor 216 of FIG. 2 and FIG. 3, backbone network 214 may extract features from images of image frames 202. At feature concatenation 304 of FIG. 3, feature propagator 218 may concatenate the features to generate feature concatenation 304 of FIG. 3. At Residual CNN 308 of FIG. 3, feature propagator 218 may generate concatenated feature maps 310 of FIG. 3. At feature reconstructor 220 of FIG. 2 and FIG. 3, backbone network 214 may generate backbone feature maps 222 based on concatenated feature maps 310.

At block 508, the computing device (or one or more components thereof) may generate a modified image based on the refined first feature maps and the second feature maps. For example, up-sampling network 224 of FIG. 2 may generate predicted results 226 of FIG. 2 based on refined scale-aware feature maps 212 and backbone feature maps 222.

In some aspects, to generate the modified image, the computing device (or one or more components thereof) may combine pixels from the refined first feature maps and the second feature maps to generate combined feature maps and generate the modified image based on the combined feature maps. For example, up-sampling network 224 of FIG. 2 and FIG. 4 may combine pixels from refined scale-aware feature maps 212 and backbone feature maps 222 and generate predicted results 226 based on the combined feature maps.

In some aspects, to generate the modified image, the computing device (or one or more components thereof) may: combine pixels from multiple refined first feature maps of the first input image to generate shuffled refined first feature maps; concatenate the shuffled refined first feature maps with second feature maps to generate shuffled combined feature maps; and generate the modified image based on the shuffled combined feature maps. For example, up-sampling network 224 of FIG. 2 and FIG. 4 may combine pixels from refined scale-aware feature maps 212 and backbone feature maps 222, concatenate the combined feature maps, and generate predicted results 226 based on the concatenated combined feature maps.

In some aspects, to generate the modified image based on the shuffled combined feature maps, the computing device (or one or more components thereof) may process the shuffled combined feature maps using a convolutional network to generate predicted image data. For example, up-sampling network 224 of FIG. 2 and FIG. 4 may process the shuffled combined feature maps using CNN 422 of FIG. 4.

In some aspects, to generate the modified image based on the combined feature maps, the computing device (or one or more components thereof) may down-scale the predicted image data based on the target scale ratio to generate the modified image. For example, post-processor 228 of FIG. 2 may down-scale predicted results 226 to generate SR image frames 230.

In some aspects, the first input image and the second input image may be, or may include, frames of video data. The computing device (or one or more components thereof) may generate modified video data based on the modified image (e.g., by repeating one or more of the blocks of process 500 for one or more additional frames of the video data). For example, image frames 202 may be, or may include, frames of video data and system 200 may process multiple frames of image frames 202.

In some aspects, the first input image may represent a region of interest of the first input image with a first number of pixels. The modified image may represents the region of interest with a second number of pixels. The second number of pixels may be greater than the first number of pixels. For example, the first input image may be ROI 104 of FIG. 1 and the modified image may be SR video 112 of FIG. 1.

In some aspects, a relationship between the second number of pixels and the first number of pixels is based on the target scale ratio. For example, a relationship between the number of pixels of ROI 104 and the number of pixels of SR video 112 may be based on scale ratio 108.

In some aspects, a ratio between second number of pixels and the first number of pixels is defined by a real number that is not an integer. For example, the ratio between the size of ROI 104 and SR video 112 may be a real number. In some cases, the ratio may be an integer, for example, 2, 3, 4, etc. In other cases, the ratio may be a real number that is not an integer, for example, 2.01, 9/4, 2.5, 8/3, e, π, and 22/7.

In some aspects, the computing device (or one or more components thereof) may receive an indication of the region of interest. For example, system 100 may receive an indication of ROI 104.

In some aspects, the region of interest may be based on an indication based on a user input. For example, ROI 104 may be identified based on a user input.

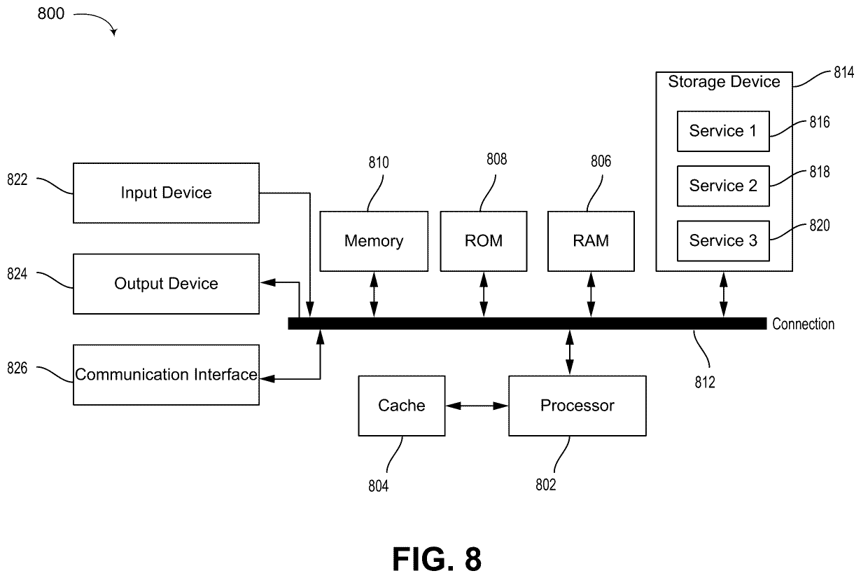

In some examples, as noted previously, the methods described herein (e.g., process 500 of FIG. 5, and/or other methods described herein) can be performed, in whole or in part, by a computing device or apparatus. In one example, one or more of the methods can be performed by 200 of FIG. 2, or by another system or device. In another example, one or more of the methods (e.g., process 500 of FIG. 5, and/or other methods described herein) can be performed, in whole or in part, by the computing-device architecture 800 shown in FIG. 8. For instance, a computing device with the computing-device architecture 800 shown in FIG. 8 can include, or be included in, the components of the system 200 and can implement the operations of process 500, and/or other process described herein. In some cases, the computing device or apparatus can include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device can include a display, a network interface configured to communicate and/or receive the data, any combination thereof, and/or other component(s). The network interface can be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

Process 500, and/or other process described herein are illustrated as logical flow diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, process 500, and/or other process described herein can be performed under the control of one or more computer systems configured with executable instructions and can be implemented as code (e.g., executable instructions, one or more computer programs, or one or more applications) executing collectively on one or more processors, by hardware, or combinations thereof. As noted above, the code can be stored on a computer-readable or machine-readable storage medium, for example, in the form of a computer program comprising a plurality of instructions executable by one or more processors. The computer-readable or machine-readable storage medium can be non-transitory.

As noted above, various aspects of the present disclosure can use machine-learning models or systems.

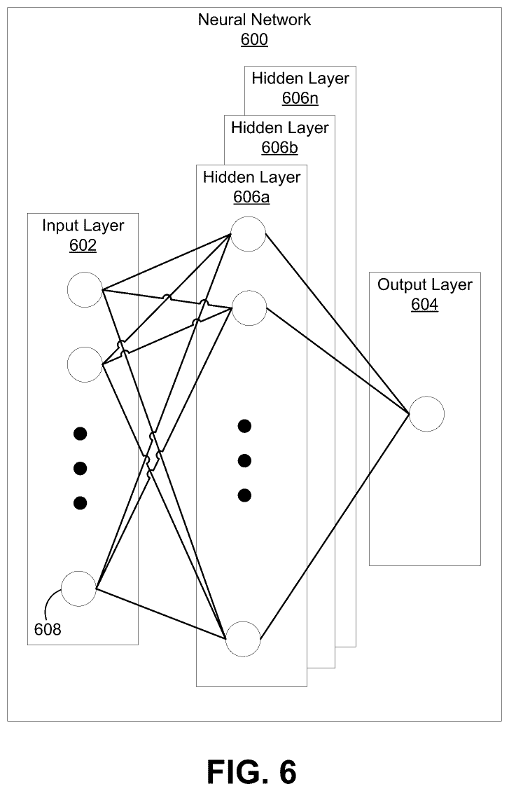

FIG. 6 is an illustrative example of a neural network 600 (e.g., a deep-learning neural network) that can be used to implement machine-learning based feature segmentation, implicit-neural-representation generation, rendering, classification, object detection, image recognition (e.g., face recognition, object recognition, scene recognition, etc.), feature extraction, authentication, gaze detection, gaze prediction, and/or automation. For example, neural network 600 may be an example of, or can implement, feature extractor 216 of FIG. 2, feature reconstructor 220 of FIG. 2, residual CNN 308 of FIG. 3, and/or CNN 422 of FIG. 4.

An input layer 602 includes input data. In one illustrative example, input layer 602 can include data representing image frames 202 of FIG. 2 and FIG. 3, concatenated features 306, concatenated feature maps 310 of FIG. 3, the output of concatenator 420 of FIG. 4. Neural network 600 includes multiple hidden layers (e.g., hidden layers 606a, 606b, through 606n). The hidden layers 606a, 606b, through hidden layer 606n include “n” number of hidden layers, where “n” is an integer greater than or equal to one. The number of hidden layers can be made to include as many layers as needed for the given application. Neural network 600 further includes an output layer 604 that provides an output resulting from the processing performed by the hidden layers 606a, 606b, through 606n. In one illustrative example, output layer 604 can provide feature maps 302 of FIG. 3, concatenated feature maps 310 of FIG. 3, predicted results 226 of FIG. 2 and FIG. 4.

Neural network 600 may be, or may include, a multi-layer neural network of interconnected nodes. Each node can represent a piece of information. Information associated with the nodes is shared among the different layers and each layer retains information as information is processed. In some cases, neural network 600 can include a feed-forward network, in which case there are no feedback connections where outputs of the network are fed back into itself. In some cases, neural network 600 can include a recurrent neural network, which can have loops that allow information to be carried across nodes while reading in input.

Information can be exchanged between nodes through node-to-node interconnections between the various layers. Nodes of input layer 602 can activate a set of nodes in the first hidden layer 606a. For example, as shown, each of the input nodes of input layer 602 is connected to each of the nodes of the first hidden layer 606a. The nodes of first hidden layer 606a can transform the information of each input node by applying activation functions to the input node information. The information derived from the transformation can then be passed to and can activate the nodes of the next hidden layer 606b, which can perform their own designated functions. Example functions include convolutional, up-sampling, data transformation, and/or any other suitable functions. The output of the hidden layer 606b can then activate nodes of the next hidden layer, and so on. The output of the last hidden layer 606n can activate one or more nodes of the output layer 604, at which an output is provided. In some cases, while nodes (e.g., node 608) in neural network 600 are shown as having multiple output lines, a node has a single output and all lines shown as being output from a node represent the same output value.

In some cases, each node or interconnection between nodes can have a weight that is a set of parameters derived from the training of neural network 600. Once neural network 600 is trained, it can be referred to as a trained neural network, which can be used to perform one or more operations. For example, an interconnection between nodes can represent a piece of information learned about the interconnected nodes. The interconnection can have a tunable numeric weight that can be tuned (e.g., based on a training dataset), allowing neural network 600 to be adaptive to inputs and able to learn as more and more data is processed.

Neural network 600 may be pre-trained to process the features from the data in the input layer 602 using the different hidden layers 606a, 606b, through 606n in order to provide the output through the output layer 604. In an example in which neural network 600 is used to identify features in images, neural network 600 can be trained using training data that includes both images and labels, as described above. For instance, training images can be input into the network, with each training image having a label indicating the features in the images (for the feature-segmentation machine-learning system) or a label indicating classes of an activity in each image. In one example using object classification for illustrative purposes, a training image can include an image of a number 2, in which case the label for the image can be [0 0 1 0 0 0 0 0 00].

In some cases, neural network 600 can adjust the weights of the nodes using a training process called backpropagation. As noted above, a backpropagation process can include a forward pass, a loss function, a backward pass, and a weight update. The forward pass, loss function, backward pass, and parameter update are performed for one training iteration. The process can be repeated for a certain number of iterations for each set of training images until neural network 600 is trained well enough so that the weights of the layers are accurately tuned.

For the example of identifying objects in images, the forward pass can include passing a training image through neural network 600. The weights are initially randomized before neural network 600 is trained. As an illustrative example, an image can include an array of numbers representing the pixels of the image. Each number in the array can include a value from 0 to 255 describing the pixel intensity at that position in the array. In one example, the array can include a 28×28×3 array of numbers with 28 rows and 28 columns of pixels and 3 color components (such as red, green, and blue, or luma and two chroma components, or the like).

As noted above, for a first training iteration for neural network 600, the output will likely include values that do not give preference to any particular class due to the weights being randomly selected at initialization. For example, if the output is a vector with probabilities that the object includes different classes, the probability value for each of the different classes can be equal or at least very similar (e.g., for ten possible classes, each class can have a probability value of 0.1). With the initial weights, neural network 600 is unable to determine low-level features and thus cannot make an accurate determination of what the classification of the object might be. A loss function can be used to analyze error in the output. Any suitable loss function definition can be used, such as a cross-entropy loss. Another example of a loss function includes the mean squared error (MSE), defined as Eₜₒₜₐₗ=Σ½(target−output)². The loss can be set to be equal to the value of Eₜₒₜₐₗ.

The loss (or error) will be high for the first training images since the actual values will be much different than the predicted output. The goal of training is to minimize the amount of loss so that the predicted output is the same as the training label. Neural network 600 can perform a backward pass by determining which inputs (weights) most contributed to the loss of the network and can adjust the weights so that the loss decreases and is eventually minimized. A derivative of the loss with respect to the weights (denoted as dL/dW, where W are the weights at a particular layer) can be computed to determine the weights that contributed most to the loss of the network. After the derivative is computed, a weight update can be performed by updating all the weights of the filters. For example, the weights can be updated so that they change in the opposite direction of the gradient. The weight update can be denoted as w=wᵢ−ηdw/dL, where w denotes a weight, wᵢ denotes the initial weight, and f denotes a learning rate. The learning rate can be set to any suitable value, with a high learning rate including larger weight updates and a lower value indicating smaller weight updates.

Neural network 600 can include any suitable deep network. One example includes a convolutional neural network (CNN), which includes an input layer and an output layer, with multiple hidden layers between the input and out layers. The hidden layers of a CNN include a series of convolutional, nonlinear, pooling (for downsampling), and fully connected layers. Neural network 600 can include any other deep network other than a CNN, such as an autoencoder, a deep belief nets (DBNs), a Recurrent Neural Networks (RNNs), among others.

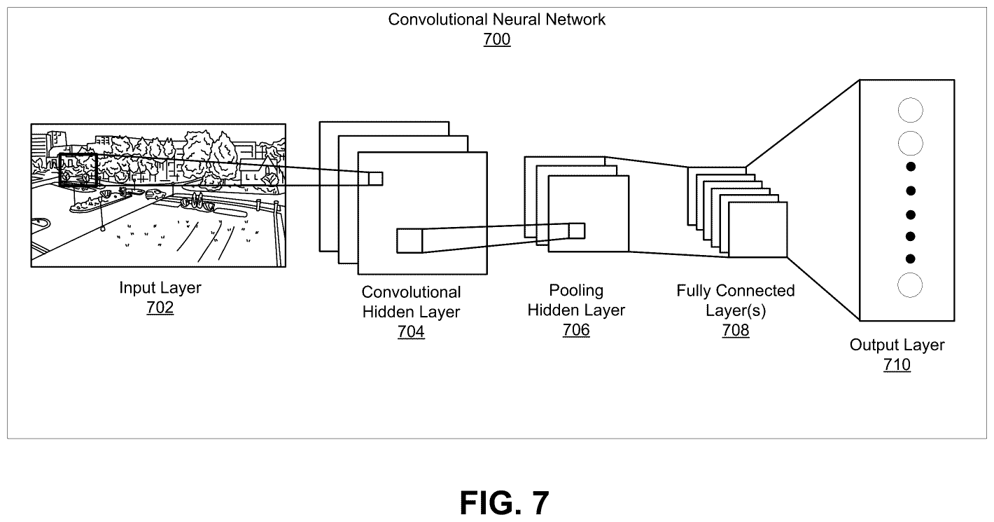

FIG. 7 is an illustrative example of a convolutional neural network (CNN) 700. The input layer 702 of the CNN 700 includes data representing an image or frame. For example, the data can include an array of numbers representing the pixels of the image, with each number in the array including a value from 0 to 255 describing the pixel intensity at that position in the array. Using the previous example from above, the array can include a 28×28×3 array of numbers with 28 rows and 28 columns of pixels and 3 color components (e.g., red, green, and blue, or luma and two chroma components, or the like). The image can be passed through a convolutional hidden layer 704, an optional non-linear activation layer, a pooling hidden layer 706, and fully connected layer 708 (which fully connected layer 708 can be hidden) to get an output at the output layer 710. While only one of each hidden layer is shown in FIG. 7, one of ordinary skill will appreciate that multiple convolutional hidden layers, non-linear layers, pooling hidden layers, and/or fully connected layers can be included in the CNN 700. As previously described, the output can indicate a single class of an object or can include a probability of classes that best describe the object in the image.

The first layer of the CNN 700 can be the convolutional hidden layer 704. The convolutional hidden layer 704 can analyze image data of the input layer 702. Each node of the convolutional hidden layer 704 is connected to a region of nodes (pixels) of the input image called a receptive field. The convolutional hidden layer 704 can be considered as one or more filters (each filter corresponding to a different activation or feature map), with each convolutional iteration of a filter being a node or neuron of the convolutional hidden layer 704. For example, the region of the input image that a filter covers at each convolutional iteration would be the receptive field for the filter. In one illustrative example, if the input image includes a 28×28 array, and each filter (and corresponding receptive field) is a 5×5 array, then there will be 24×24 nodes in the convolutional hidden layer 704. Each connection between a node and a receptive field for that node learns a weight and, in some cases, an overall bias such that each node learns to analyze its particular local receptive field in the input image. Each node of the convolutional hidden layer 704 will have the same weights and bias (called a shared weight and a shared bias). For example, the filter has an array of weights (numbers) and the same depth as the input. A filter will have a depth of 3 for an image frame example (according to three color components of the input image). An illustrative example size of the filter array is 5×5×3, corresponding to a size of the receptive field of a node.

The convolutional nature of the convolutional hidden layer 704 is due to each node of the convolutional layer being applied to its corresponding receptive field. For example, a filter of the convolutional hidden layer 704 can begin in the top-left corner of the input image array and can convolve around the input image. As noted above, each convolutional iteration of the filter can be considered a node or neuron of the convolutional hidden layer 704. At each convolutional iteration, the values of the filter are multiplied with a corresponding number of the original pixel values of the image (e.g., the 5×5 filter array is multiplied by a 5×5 array of input pixel values at the top-left corner of the input image array). The multiplications from each convolutional iteration can be summed together to obtain a total sum for that iteration or node. The process is next continued at a next location in the input image according to the receptive field of a next node in the convolutional hidden layer 704. For example, a filter can be moved by a step amount (referred to as a stride) to the next receptive field. The stride can be set to 1 or any other suitable amount. For example, if the stride is set to 1, the filter will be moved to the right by 1 pixel at each convolutional iteration. Processing the filter at each unique location of the input volume produces a number representing the filter results for that location, resulting in a total sum value being determined for each node of the convolutional hidden layer 704.

The mapping from the input layer to the convolutional hidden layer 704 is referred to as an activation map (or feature map). The activation map includes a value for each node representing the filter results at each location of the input volume. The activation map can include an array that includes the various total sum values resulting from each iteration of the filter on the input volume. For example, the activation map will include a 24×24 array if a 5×5 filter is applied to each pixel (a stride of 1) of a 28×28 input image. The convolutional hidden layer 704 can include several activation maps in order to identify multiple features in an image. The example shown in FIG. 7 includes three activation maps. Using three activation maps, the convolutional hidden layer 704 can detect three different kinds of features, with each feature being detectable across the entire image.

In some examples, a non-linear hidden layer can be applied after the convolutional hidden layer 704. The non-linear layer can be used to introduce non-linearity to a system that has been computing linear operations. One illustrative example of a non-linear layer is a rectified linear unit (ReLU) layer. A ReLU layer can apply the function f(x)=max(0, x) to all of the values in the input volume, which changes all the negative activations to 0. The ReLU can thus increase the non-linear properties of the CNN 700 without affecting the receptive fields of the convolutional hidden layer 704.

The pooling hidden layer 706 can be applied after the convolutional hidden layer 704 (and after the non-linear hidden layer when used). The pooling hidden layer 706 is used to simplify the information in the output from the convolutional hidden layer 704. For example, the pooling hidden layer 706 can take each activation map output from the convolutional hidden layer 704 and generates a condensed activation map (or feature map) using a pooling function. Max-pooling is one example of a function performed by a pooling hidden layer. Other forms of pooling functions be used by the pooling hidden layer 706, such as average pooling, L2-norm pooling, or other suitable pooling functions. A pooling function (e.g., a max-pooling filter, an L2-norm filter, or other suitable pooling filter) is applied to each activation map included in the convolutional hidden layer 704. In the example shown in FIG. 7, three pooling filters are used for the three activation maps in the convolutional hidden layer 704.

In some examples, max-pooling can be used by applying a max-pooling filter (e.g., having a size of 2×2) with a stride (e.g., equal to a dimension of the filter, such as a stride of 2) to an activation map output from the convolutional hidden layer 704. The output from a max-pooling filter includes the maximum number in every sub-region that the filter convolves around. Using a 2×2 filter as an example, each unit in the pooling layer can summarize a region of 2×2 nodes in the previous layer (with each node being a value in the activation map). For example, four values (nodes) in an activation map will be analyzed by a 2×2 max-pooling filter at each iteration of the filter, with the maximum value from the four values being output as the “max” value. If such a max-pooling filter is applied to an activation filter from the convolutional hidden layer 704 having a dimension of 24×24 nodes, the output from the pooling hidden layer 706 will be an array of 12×12 nodes.

In some examples, an L2-norm pooling filter could also be used. The L2-norm pooling filter includes computing the square root of the sum of the squares of the values in the 2×2 region (or other suitable region) of an activation map (instead of computing the maximum values as is done in max-pooling) and using the computed values as an output.

The pooling function (e.g., max-pooling, L2-norm pooling, or other pooling function) determines whether a given feature is found anywhere in a region of the image and discards the exact positional information. This can be done without affecting results of the feature detection because, once a feature has been found, the exact location of the feature is not as important as its approximate location relative to other features. Max-pooling (as well as other pooling methods) offer the benefit that there are many fewer pooled features, thus reducing the number of parameters needed in later layers of the CNN 700.

The final layer of connections in the network is a fully-connected layer that connects every node from the pooling hidden layer 706 to every one of the output nodes in the output layer 710. Using the example above, the input layer includes 28×28 nodes encoding the pixel intensities of the input image, the convolutional hidden layer 704 includes 3×24×24 hidden feature nodes based on application of a 5×5 local receptive field (for the filters) to three activation maps, and the pooling hidden layer 706 includes a layer of 3×12×12 hidden feature nodes based on application of max-pooling filter to 2×2 regions across each of the three feature maps. Extending this example, the output layer 710 can include ten output nodes. In such an example, every node of the 3×12×12 pooling hidden layer 706 is connected to every node of the output layer 710.

The fully connected layer 708 can obtain the output of the previous pooling hidden layer 706 (which should represent the activation maps of high-level features) and determines the features that most correlate to a particular class. For example, the fully connected layer 708 can determine the high-level features that most strongly correlate to a particular class and can include weights (nodes) for the high-level features. A product can be computed between the weights of the fully connected layer 708 and the pooling hidden layer 706 to obtain probabilities for the different classes. For example, if the CNN 700 is being used to predict that an object in an image is a person, high values will be present in the activation maps that represent high-level features of people (e.g., two legs are present, a face is present at the top of the object, two eyes are present at the top left and top right of the face, a nose is present in the middle of the face, a mouth is present at the bottom of the face, and/or other features common for a person).

In some examples, the output from the output layer 710 can include an M-dimensional vector (in the prior example, M=10). M indicates the number of classes that the CNN 700 has to choose from when classifying the object in the image. Other example outputs can also be provided. Each number in the M-dimensional vector can represent the probability the object is of a certain class. In one illustrative example, if a 10-dimensional output vector represents ten different classes of objects is [0 0 0.05 0.8 0 0.15 0 0 0 0], the vector indicates that there is a 5% probability that the image is the third class of object (e.g., a dog), an 80% probability that the image is the fourth class of object (e.g., a human), and a 15% probability that the image is the sixth class of object (e.g., a kangaroo). The probability for a class can be considered a confidence level that the object is part of that class.

FIG. 8 illustrates an example computing-device architecture 800 of an example computing device which can implement the various techniques described herein. In some examples, the computing device can include a mobile device, a wearable device, an extended reality device (e.g., a virtual reality (VR) device, an augmented reality (AR) device, or a mixed reality (MR) device), a personal computer, a laptop computer, a video server, a vehicle (or computing device of a vehicle), or other device. For example, the computing-device architecture 800 may include, implement, or be included in system 200. Additionally or alternatively, computing-device architecture 800 may be configured to perform process 500, and/or other process described herein.

The components of computing-device architecture 800 are shown in electrical communication with each other using connection 812, such as a bus. The example computing-device architecture 800 includes a processing unit (CPU or processor) 802 and computing device connection 812 that couples various computing device components including computing device memory 810, such as read only memory (ROM) 808 and random-access memory (RAM) 806, to processor 802.

Computing-device architecture 800 can include a cache of high-speed memory connected directly with, in close proximity to, or integrated as part of processor 802. Computing-device architecture 800 can copy data from memory 810 and/or the storage device 814 to cache 804 for quick access by processor 802. In this way, the cache can provide a performance boost that avoids processor 802 delays while waiting for data. These and other modules can control or be configured to control processor 802 to perform various actions. Other computing device memory 810 may be available for use as well. Memory 810 can include multiple different types of memory with different performance characteristics. Processor 802 can include any general-purpose processor and a hardware or software service, such as service 1 816, service 2 818, and service 3 820 stored in storage device 814, configured to control processor 802 as well as a special-purpose processor where software instructions are incorporated into the processor design. Processor 802 may be a self-contained system, containing multiple cores or processors, a bus, memory controller, cache, etc. A multi-core processor may be symmetric or asymmetric.

To enable user interaction with the computing-device architecture 800, input device 822 can represent any number of input mechanisms, such as a microphone for speech, a touch-sensitive screen for gesture or graphical input, keyboard, mouse, motion input, speech and so forth. Output device 824 can also be one or more of a number of output mechanisms known to those of skill in the art, such as a display, projector, television, speaker device, etc. In some instances, multimodal computing devices can enable a user to provide multiple types of input to communicate with computing-device architecture 800. Communication interface 826 can generally govern and manage the user input and computing device output. There is no restriction on operating on any particular hardware arrangement and therefore the basic features here may easily be substituted for improved hardware or firmware arrangements as they are developed.

Storage device 814 is a non-volatile memory and can be a hard disk or other types of computer readable media which can store data that are accessible by a computer, such as magnetic cassettes, flash memory cards, solid state memory devices, digital versatile disks, cartridges, random-access memories (RAMs) 806, read only memory (ROM) 808, and hybrids thereof. Storage device 814 can include services 816, 818, and 820 for controlling processor 802. Other hardware or software modules are contemplated. Storage device 814 can be connected to the computing device connection 812. In one aspect, a hardware module that performs a particular function can include the software component stored in a computer-readable medium in connection with the necessary hardware components, such as processor 802, connection 812, output device 824, and so forth, to carry out the function.

The term “substantially,” in reference to a given parameter, property, or condition, may refer to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

Aspects of the present disclosure are applicable to any suitable electronic device (such as security systems, smartphones, tablets, laptop computers, vehicles, drones, or other devices) including or coupled to one or more active depth sensing systems. While described below with respect to a device having or coupled to one light projector, aspects of the present disclosure are applicable to devices having any number of light projectors and are therefore not limited to specific devices.

The term “device” is not limited to one or a specific number of physical objects (such as one smartphone, one controller, one processing system and so on). As used herein, a device may be any electronic device with one or more parts that may implement at least some portions of this disclosure. While the below description and examples use the term “device” to describe various aspects of this disclosure, the term “device” is not limited to a specific configuration, type, or number of objects. Additionally, the term “system” is not limited to multiple components or specific aspects. For example, a system may be implemented on one or more printed circuit boards or other substrates and may have movable or static components. While the below description and examples use the term “system” to describe various aspects of this disclosure, the term “system” is not limited to a specific configuration, type, or number of objects.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, magnetic or optical disks, USB devices provided with non-volatile memory, networked storage devices, any suitable combination thereof, among others. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general-purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium including program code including instructions that, when executed, performs one or more of the methods described above. The computer-readable data storage medium may form part of a computer program product, which may include packaging materials. The computer-readable medium may include memory or data storage media, such as random-access memory (RAM) such as synchronous dynamic random-access memory (SDRAM), read-only memory (ROM), non-volatile random-access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general-purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the disclosure include:

Aspect 1. An apparatus for modifying images, the apparatus comprising: at least one memory; and at least one processor coupled to the at least one memory and configured to: generate first feature maps based on a first input image and a target scale ratio; refine the first feature maps to generate refined first feature maps; generate second feature maps based on the first input image and a second input image; and generate a modified image based on the refined first feature maps and the second feature maps.

Aspect 2. The apparatus of aspect 1, wherein, to generate the first feature maps, the at least one processor is configured to calculate.

Aspect 3. The apparatus of any one of aspects 1 or 2, wherein, to generate the first feature maps, the at least one processor is configured to project, based on the target scale ratio and a size of the first input image, pixel coordinates of a high-resolution image space to a low-resolution image space to determine pixel coordinates of the low-resolution image space.

Aspect 4. The apparatus of aspect 3, wherein the at least one processor is further configured to determine relative distances between the pixel coordinates of a high-resolution image space and the pixels coordinates of the low-resolution image space.

Aspect 5. The apparatus of any one of aspects 1 to 4, wherein, to refine the first feature maps, the at least one processor is configured to use.

Aspect 6. The apparatus of any one of aspects 1 to 5, wherein, to generate the second feature maps, the at least one processor is configured to: extract first features from the first input image; extract second features from the second input image; concatenate generate, using a residual block, concatenated feature maps based on the concatenated features; and reconstruct the concatenated feature maps to generate the second feature maps.

Aspect 7. The apparatus of any one of aspects 1 to 6, wherein, to generate the modified image, the at least one processor is configured to: combine pixels from the refined first feature maps and the second feature maps to generate combined feature maps; and generate the modified image based on the combined feature maps.

Aspect 8. The apparatus of any one of aspects 1 to 7, wherein, to generate the modified image, the at least one processor is configured to: combine pixels from multiple refined first feature maps of the first input image to generate shuffled refined first feature maps; concatenate the shuffled refined first feature maps with second feature maps to generate shuffled combined feature maps; and generate the modified image based on the shuffled combined feature maps.

Aspect 9. The apparatus of aspect 8, wherein, to generate the modified image based on the shuffled combined feature maps, the at least one processor is configured to process the shuffled combined feature maps using a convolutional network to generate predicted image data.

Aspect 10. The apparatus of aspect 9, wherein, to generate the modified image based on the combined feature maps, the at least one processor is further configured to down-scale the predicted image data based on the target scale ratio to generate the modified image.

Aspect 11. The apparatus of any one of aspects 1 to 10, wherein the first input image and the second input image comprise frames of video data, and wherein the at least one processor is further configured to generate modified video data based on the modified image.

Aspect 12. The apparatus of any one of aspects 1 to 11, wherein the first input image represents a region of interest of the first input image with a first number of pixels, wherein the modified image represents the region of interest with a second number of pixels, and wherein the second number of pixels is greater than the first number of pixels.

Aspect 13. The apparatus of aspect 12, wherein a relationship between the second number of pixels and the first number of pixels is based on the target scale ratio.

Aspect 14. The apparatus of any one of aspects 12 or 13, wherein a ratio between second number of pixels and the first number of pixels is defined by a real number that is not an integer.

Aspect 15. The apparatus of any one of aspects 12 to 14, wherein the at least one processor is further configured to receive an indication of the region of interest.

Aspect 16. The apparatus of any one of aspects 12 to 15, wherein the region of interest is based on an indication based on a user input.

Aspect 17. A method for modifying images, the method comprising: generating first feature maps based on a first input image and a target scale ratio; refining the first feature maps to generate refined first feature maps; generating second feature maps based on the first input image and a second input image; and generating a modified image based on the refined first feature maps and the second feature maps.

Aspect 18. The method of aspect 17, wherein generating the first feature maps comprises calculating coordinates and relative distances based on the first input image and the target scale ratio.

Aspect 19. The method of any one of aspects 17 or 18, wherein generating the first feature maps comprises projecting, based on the target scale ratio and a size of the first input image, pixel coordinates of a high-resolution image space to a low-resolution image space to determine pixel coordinates of the low-resolution image space.

Aspect 20. The method of aspect 19, further comprising determining relative distances between the pixel coordinates of a high-resolution image space and the pixels coordinates of the low-resolution image space.

Aspect 21. The method of any one of aspects 17 to 20, wherein refining the first feature maps comprises using a scale-aware machine-learning model to generate the refined first feature maps based on the first feature maps.

Aspect 22. The method of any one of aspects 17 to 21, wherein generating the second feature maps comprises: extracting first features from the first input image; extracting second features from the second input image; concatenating the first features with the second features to generate concatenated features; generating, using a residual block, concatenated feature maps based on the concatenated features; and reconstructing the concatenated feature maps to generate the second feature maps.

Aspect 23. The method of any one of aspects 17 to 22, wherein generating the modified image comprises: combining pixels from the refined first feature maps and the second feature maps to generate combined feature maps; and generating the modified image based on the combined feature maps.

Aspect 24. The method of any one of aspects 17 to 23, wherein generating the modified image comprises: combining pixels from multiple refined first feature maps of the first input image to generate shuffled refined first feature maps; concatenating the shuffled refined first feature maps with second feature maps to generate shuffled combined feature maps; and generating the modified image based on the shuffled combined feature maps.

Aspect 25. The method of aspect 24, wherein generating the modified image based on the shuffled combined feature maps comprises processing the shuffled combined feature maps using a convolutional network to generate predicted image data.

Aspect 26. The method of aspect 25, wherein generating the modified image based on the shuffled combined feature maps further comprises down-scaling the predicted image data based on the target scale ratio to generate the modified image.

Aspect 27. The method of any one of aspects 17 to 26, wherein the first input image and the second input image comprise frames of video data, and further comprising generating modified video data based on the modified image.

Aspect 28. The method of any one of aspects 17 to 27, wherein the first input image represents a region of interest of the first input image with a first number of pixels, wherein the modified image represents the region of interest with a second number of pixels, and wherein the second number of pixels is greater than the first number of pixels.

Aspect 29. The method of aspect 28, wherein a relationship between the second number of pixels and the first number of pixels is based on the target scale ratio.

Aspect 30. The method of any one of aspects 28 or 29, wherein a ratio between second number of pixels and the first number of pixels is defined by a real number that is not an integer.

Aspect 31. The method of any one of aspects 28 to 30, further comprising receiving an indication of the region of interest.

Aspect 32. The method of any one of aspects 28 to 31, wherein the region of interest is based on an indication based on a user input.

Aspect 33. A non-transitory computer-readable storage medium having stored thereon instructions that, when executed by at least one processor, cause the at least one processor to perform operations according to any of aspects 17 to 32.

Aspect 34. An apparatus for providing virtual content for display, the apparatus comprising one or more means for perform operations according to any of aspects 17 to 32.

What is claimed is:

1. An apparatus for modifying images, the apparatus comprising:
at least one memory; and
at least one processor coupled to the at least one memory and configured to:
generate first feature maps based on a first input image and a target scale ratio;
refine the first feature maps to generate refined first feature maps;
generate second feature maps based on the first input image and a second input image; and
generate a modified image based on the refined first feature maps and the second feature maps.

2. The apparatus of claim 1, wherein, to generate the first feature maps, the at least one processor is configured to calculate coordinates and relative distances based on the first input image and the target scale ratio.

3. The apparatus of claim 1, wherein, to generate the first feature maps, the at least one processor is configured to project, based on the target scale ratio and a size of the first input image, pixel coordinates of a high-resolution image space to a low-resolution image space to determine pixel coordinates of the low-resolution image space.

4. The apparatus of claim 3, wherein the at least one processor is further configured to determine relative distances between the pixel coordinates of a high-resolution image space and the pixel coordinates of the low-resolution image space.

5. The apparatus of claim 1, wherein, to refine the first feature maps, the at least one processor is configured to use a scale-aware machine-learning model to generate the refined first feature maps based on the first feature maps.

6. The apparatus of claim 1, wherein, to generate the second feature maps, the at least one processor is configured to:
extract first features from the first input image;
extract second features from the second input image;
concatenate the first features with the second features to generate concatenated features;
generate, using a residual block, concatenated feature maps based on the concatenated features; and
reconstruct the concatenated feature maps to generate the second feature maps.

7. The apparatus of claim 1, wherein, to generate the modified image, the at least one processor is configured to:
combine pixels from the refined first feature maps and the second feature maps to generate combined feature maps; and
generate the modified image based on the combined feature maps.

8. The apparatus of claim 1, wherein, to generate the modified image, the at least one processor is configured to:
combine pixels from multiple refined first feature maps of the first input image to generate shuffled refined first feature maps;
concatenate the shuffled refined first feature maps with second feature maps to generate shuffled combined feature maps; and
generate the modified image based on the shuffled combined feature maps.

9. The apparatus of claim 8, wherein, to generate the modified image based on the shuffled combined feature maps, the at least one processor is configured to process the shuffled combined feature maps using a convolutional network to generate predicted image data.

10. The apparatus of claim 9, wherein, to generate the modified image based on the shuffled combined feature maps, the at least one processor is further configured to down-scale the predicted image data based on the target scale ratio to generate the modified image.

11. The apparatus of claim 1, wherein the first input image and the second input image comprise frames of video data, and wherein the at least one processor is further configured to generate modified video data based on the modified image.

12. The apparatus of claim 1, wherein the first input image represents a region of interest of the first input image with a first number of pixels, wherein the modified image represents the region of interest with a second number of pixels, and wherein the second number of pixels is greater than the first number of pixels.

13. The apparatus of claim 12, wherein a relationship between the second number of pixels and the first number of pixels is based on the target scale ratio.

14. The apparatus of claim 12, wherein a ratio between second number of pixels and the first number of pixels is defined by a real number that is not an integer.

15. The apparatus of claim 12, wherein the at least one processor is further configured to receive an indication of the region of interest.

16. The apparatus of claim 12, wherein the region of interest is based on an indication based on a user input.

17. A method for modifying images, the method comprising:
generating first feature maps based on a first input image and a target scale ratio;
refining the first feature maps to generate refined first feature maps;
generating second feature maps based on the first input image and a second input image; and
generating a modified image based on the refined first feature maps and the second feature maps.

18. The method of claim 17, wherein generating the first feature maps comprises calculating coordinates and relative distances based on the first input image and the target scale ratio.

19. The method of claim 17, wherein generating the first feature maps comprises projecting, based on the target scale ratio and a size of the first input image, pixel coordinates of a high-resolution image space to a low-resolution image space to determine pixel coordinates of the low-resolution image space.

20. The method of claim 19, further comprising determining relative distances between the pixel coordinates of a high-resolution image space and the pixel coordinates of the low-resolution image space.
